(19) United States
(12) Patent Application Publication
(10) Pub. No.: US 2019/0102994 A1
(43) Pub. Date: Apr. 4, 2019

(54) GAMING MACHINE AND METHOD FOR INTEGRATING NEW BONUS SCHEMES TO EXISTING GAMES

(71) Applicant: Everi Games, Inc., Austin, TX (US)

(72) Inventors: Keith Riggs, Austin, TX (US); Steven Meyer, Austin, TX (US); Paul Klingensmith, Austin, TX (US); Loren Jacobs, Austin, TX (US)

(73) Assignee: Everi Games, Inc., Austin, TX (US)

(21) Appl. No.: 15/879,653

(22) Filed: Jan. 25, 2018

Related U.S. Application Data
(60) Provisional application No. 62/566,499, filed on Oct. 1, 2017.

(51) Int. Cl. G07F 17/32

(52) U.S. Cl. CPC G07F 17/3267; G07F 17/3244; G07F 17/3225

(57) ABSTRACT

Methods and systems are disclosed providing improved execution and management of slot machine game software. Base game and add-on bonus game modules are provided that have independent regulatory approval. The modules are installed on a gaming machine and executed with independent wager contributions and results, but with a sequential display of results presented as a single game round to the player. A module structure is provided allowing distribution and execution of such base and bonus game modules. Methods and software are provided for integrating presentation of results from multiple modules, reporting the results to accounting services.

### CROSS-REFERENCE TO RELATED APPLICATIONS

This application claims the benefit of U.S. Provisional Application No. 62/566,499 filed Oct. 1, 2017, titled “Gaming Machine And Method For Integrating New Bonus Schemes To Existing Games,” which application is hereby incorporated by reference for all purposes.

### FIELD OF THE INVENTION

This invention relates to gaming systems and to gaming machines through which players may participate in wagering games, and in particular schemes for updating and executing bonus and add-on game features while complying with regulatory requirements for game accounting.

### BACKGROUND

Many different types of gaming machines have been developed to provide various formats and graphic presentations for conducting games and presenting game results. For example, numerous mechanical reel-type gaming machines, also known as slot machines, have been developed with different reel configurations, reel symbols, and paylines. More recently, gaming machines have been developed with video monitors that are used to produce simulations of mechanical spinning reels. These video-based gaming machines may use one or more video monitors to provide a wide variety of graphic effects in addition to simulated spinning reels, and may also provide secondary/bonus games using different reel arrangements or entirely different graphics. Video-based gaming machines may also be used to show card games or various types of competitions such as simulated horse races in which wagers may be placed.

Game manufacturers are continuously pressed to develop new game presentations, formats, and game graphics in an attempt to provide high entertainment value for players and thereby attract and keep players. One such improvement is the use of bonus game features to add chances for larger prizes to the game. However, adding such features to existing networked slot machine games presents unique difficulties. Traditionally, slot games contained a static bet structure. Since the prize distribution and RTP (return to player) of a slot game are based on the available bets, any new add-on bonuses have very little room for additional payout. Restrictions around RTP (return to player) prevent games from being configured below a jurisdictionally acceptable minimum or above a jurisdictionally acceptable maximum. Such restrictions typically limit a game configuration to have an RTP between 85% and 98%. This means that adding bonus games or side bet games to an existing game would not be able to increase the RTP by more than 13% in a “best case” scenario. Practically, most operators do not wish to add features that add significant percentage to the RTP above the existing configuration of the base game for which the business costs is already accounted for in the casino's cash flow structure. The result is that if bonus features are added to a game, they typically contribute a very small percentage to the RTP and lack the desired excitement of high payouts. These concerns also greatly limit the ability to add new bonus features to a game without re-designing the entire game math (the payout structure and how it is accomplished).

What is needed are ways to provide variability in the payout structure of existing slot machine games, while complying with regulations and business needs of casino operators.

### SUMMARY OF THE INVENTION

Methods and systems are disclosed providing improved execution and management of slot machine game software. Base game and add-on bonus game modules are provided that have independent regulatory approval. The modules are installed on a gaming machine and executed with independent wager contributions and results, but with a sequential display of results presented as a single game round to the player. A module structure is provided allowing distribution and execution of such base and bonus game modules. Methods and software are provided for integrating presentation of results from multiple modules, reporting the results to accounting services.

According to one aspect of the invention, a method of providing wagering game for presenting results from separate game modules as a single game round to a player. A module structure is provided for achieving the method using independent prize generators but a single game engine executing program code and displaying graphics from the separate base game and add-on bonus game modules. Methods and software are provided for installing and configuring the modules.

Another aspect of the invention is a computer program stored on a non-transitory readable medium. The software version is, of course, typically designed to be executed by a gaming machine or networked gaming system. The software includes multiple portions of computer executable code referred to as program code. Gaming results are provided in response to a wager and displayed by display program code that generates simulated slot reels each including one or more symbol locations. The program also has game controller program code for determining game play results involving spins or other randomization of an array of symbols, and providing the feature game selection method or the wheel enhancement feature game mode and its animations.

Another aspect of the invention is a gaming system that includes one or more gaming servers, and a group of electronic gaming machines connected to the servers by a network, programmed to provide one of more of the methods described herein. The various functionality described herein may be distributed between the electronic gaming machines and the gaming servers in any practically functional way. For example, the current preferred architecture is for the servers to determine all aspects of game logic, random number generation, and prize awards. The gaming machines provide functionality of interfacing with the player and animating the game results to present the results received from the server in an entertaining manner. However, other embodiments of course might use a thin client architecture in which the animation is also conducted by the server and electronic gaming machines serve merely as a terminal to receive button or touchscreen input from the player and to display graphics received from the server.

Different features may be included in different versions of the invention. These and other advantages and features of the invention will be apparent from the following description of the preferred embodiments, considered along with the accompanying drawings.

### BRIEF DESCRIPTION OF THE DRAWINGS

FIG. 1 is a flowchart of a game modification process according to an example embodiment.

FIG. 2 is a block diagram of data structures employed according to the example process of FIG. 1.

FIG. 3 is a flowchart of an example process for executing a base game in combination with an add-on bonus as configured in the example of FIG. 1 and FIG. 2.

FIG. 4 shows an example diagram of how the RTP is modified through the use of add-on bonus modules.

FIG. 5 is a perspective view of a gaming machine that may be used to implement feature games according to the present invention.

FIG. 6 is a system block diagram of an example gaming machine.

FIG. 7 is a network block diagram of an example gaming network.

FIG. 8 is a game screen diagram illustrating an example base game mode.

### DETAILED DESCRIPTION OF EXAMPLE EMBODIMENTS

Provided are systems and methods of reconfiguring a gaming machine to add or remove add-on bonus features to an existing base game on the gaming machine, based on the Nitro™ media management system from the assignee of the present invention, Everi Games. Also provided are systems and methods employing the new add-on bonus structure to provide wagering games. While the add-on bonus technology herein, known as “Nitro™ Bonus,” is a linked bonus product available through the Nitro™ system, other suitable systems may also employ such technology. The an add-on bonus is distributed using a module structure similar to that of a base game module, a type of digital package contain all of the code, math, art and video, audio, and data required to provide a complete add-on bonus game that plays through bonus rounds, as illustrated below.

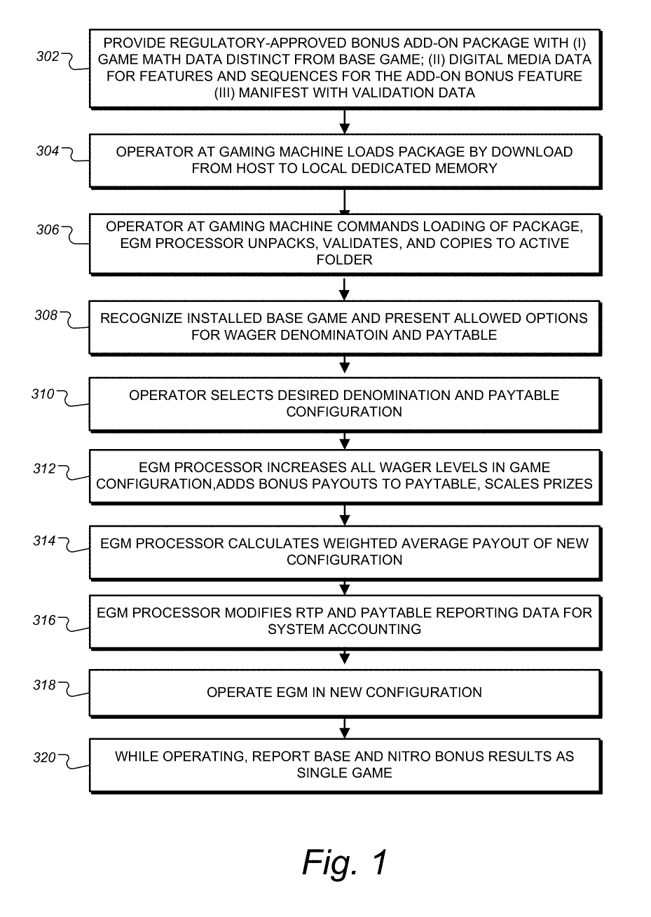

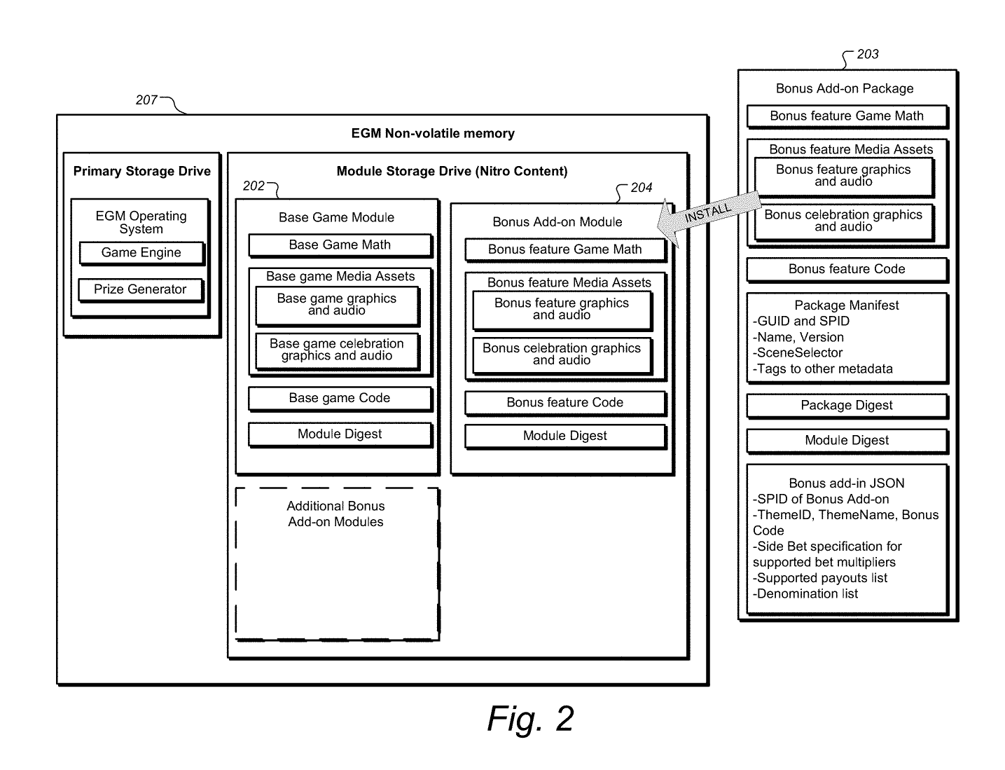

FIG. 1 is a summary flowchart of an example process for configuring an add-on bonus feature with an existing game. FIG. 2 is a block diagram of data structures employed according to the example process of FIG. 1. Referring to both figures, the depicted process provides method of reconfiguring a gaming machine to provide add-on bonus features to an existing base game on the gaming machine. The process may remove add-on features as well. The process starts at block 302, where it provides a digital add-on bonus package, which is regulatory-approved by the relevant gaming regulator because it is a functional game by itself. That is, although typically not deployed or played alone, these add-on bonus modules alone qualify for regulatory approval as a game by having independent game math and operating characteristics that allow the add-on bonus to be approved by the regulatory process to be deployed on electronic gaming machines. This allows the depicted process to install the add-on to an existing machine configured with an operating game already, resulting in the machine effectively playing multiple games that are seamlessly integrated through the gameplay and graphics presentation as a base game and bonus features. FIG. 2 shows an example diagram of the data structure for a digital add-on bonus package 203, which includes at least first data describing game math for an add-on bonus feature separately from any base game to which the add-on may be applied. As shown in the drawing, typically the add-on package 202 is added to separate module storage drive than the drive which stores EGM game engine, but this is not limiting and other security measures may instead be used. This allows a configuration server to access the module storage drive for configuring the gaming machine. The first bonus feature game math data in package 203 includes including bonus wager data and bonus payout data and definitions of the mathematical probabilities or operations to produce bonus game results based upon random numbers generated for game results. Package 203 also contains bonus feature code for executing the logic and rules of the add-on bonus game, which is preferably script code executed by a script engine portion of the game engine, but may in other embodiments be another type of program code such as executable code executed directly by the EGM processor. Package 203 also includes second digital media data including graphics and audio for all media features and sequences to be employed for executing the add-on bonus feature and any related media presentations such as the depicted bonus celebration graphics and audio. Package 203 also includes a package manifest containing validation data for said add-on bonus package including a content GUID (global unique identifier) and package SPID (unique identifier to the specific project). Name and version information are also included. A set of “Sceneselector” data is used to manage coordinated celebrations among gaming machines, containing links to media data for executing commands to display coordinated celebrations on gaming machines and overhead displays. Tags which tie other the metadata in the package to the contained bonus. The other metadata includes the package digest (which is used to validate the downloaded package, and typically encrypted with a private key for verification); the module digest, used to validate the extracted package; and a bonus add-in JSON (JavaScript Object Notation file) containing the listed information which is provided to EGMs by the add-on bonus host (the Everi Games Nitro™ host in this embodiment) for the initial add-on bonus configuration.

At block 304 the package is copied to the desired gaming machines. The package is typically downloaded via the G2S (game to system communication protocol) download process to the machine, or can be loaded from a portable memory device by the operator. Next at block 306, the process receives a command from the operator, which may be made at gaming machine or remotely at a configuration server 406 (for example, an Everi Games Nitro™ host server), to modify an existing base game of a target gaming machine based on said add-on bonus package and, in response, automatically under control of an electronic processor in the gaming machine under control of a configuration software package begins installing said add-on bonus package at block 306 by and unpacking and validating said add-on bonus package, and copying its contents to the target gaming machine. Generally the installation and configuration is shown in FIG. 2 where the add-on bonus package 203 feeds the install of the add-on bonus module 204, as shown by “Install” arrow. Next at block 308, the configuration software package recognizes the existing active base game (through its GUID or SPID) and presents configuration options that are allowed for that base game for the wagering denomination and the paytable configuration. This step may involve recognizing previously-installed add-on bonuses and either narrowing the available options due to compatibility with the existing add-on package(s), or adding options that are made available due the existing add-on package(s). Next, at block 312, the configuration software package receives selections from the operator for the desired configurations, which are typically the wagering denomination, and paytable options such as max bet and probabilities for various prizes which may be configurable.

With these configuration options, the process sat block 314 calculates a weighted average payout of the new configuration. Such a step may also be done when presenting the options by calculating a weighted average payout for each potential option and displaying it, allowing the operator to more easily select a desired configuration. Then at block 316, in the base game configuration, process increases all wager levels in a base game paytable by the bonus wager, adds the bonus payout data to the paytable and updating all references to the maximum bet, individual bets, and all prizes that scale by bet to reflect a combined bet total of the previous configuration and the add-on bonus. This includes both modifying paytable data and return to player (RTP) data on the target gaming machine for reporting to a system accounting service by adding prizes for the add-on bonus feature in the paytable data and replacing the RTP data with the calculated weighted average payout. Note that the existing base game is not removed or replaced, only data necessary to integrate the add-on bonus is modified or added to the system. This effectively merges the add-on bonus with the existing game not only from the player point of view, but also from the operator point of view, even though their game math may function separately and regulatory approval may be made separately from the base game and other add-on bonuses. Once the add-on bonus is installed, it is referred to as a add-on bonus module.

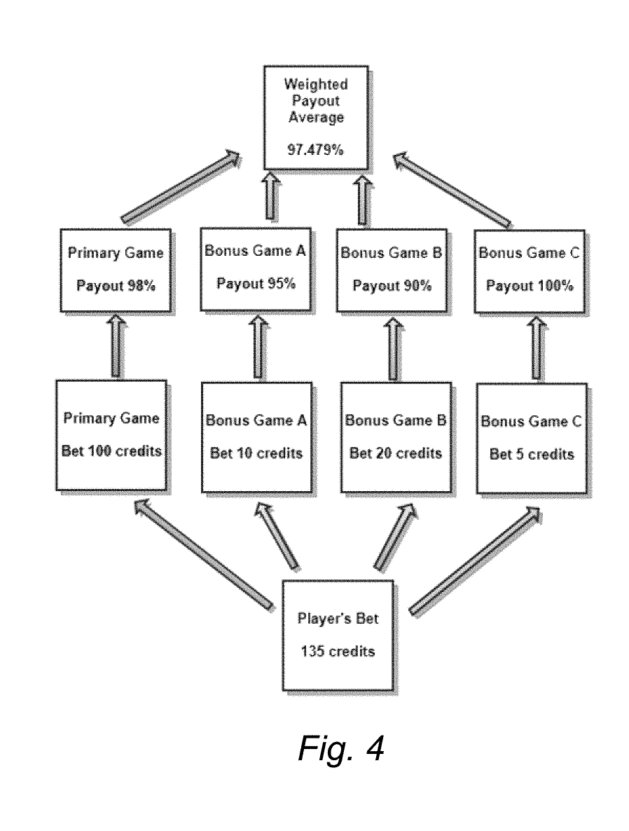

FIG. 4 shows an example diagram of how the RTP is modified through the use of add-on bonus modules. The process calculates the Aggregate Theoretical Expected Value (EV), also known as Return to Player % or weighted payout average, in one of several ways, depending on the type of primary game and Add-On Bonus configured:

For a non-progressive primary (base) game and a single add-on bonus, this calculation is a weighted average of the two payouts as shown in Equation 1.

EV=((Primary %*Bet)+(Add-On Bonus %*Add-On Bonus Bet))/(Bet+Add-On Bonus Bet) (1)

For example, a base game with a 30 credit bet and a RTP percentage of 90.20% and an add-on bonus with a 5 credit bet and an RTP of 90.55% is calculated as EV=((90.20%*30)+(90.55%*5))/(35)=90.25%.

For a base game including a progressive, and a single add-on bonus, the calculation is a weighted average which also takes the progressive contribution into account as shown in Equation 2.

EV=((Primary %*Bet)+(Add-On Bonus %*Add-On Bonus Bet))/(Bet+Add-On Bonus Bet)+ProgressiveGrowth %. (2)

For example, for the same base and add-on bonus numbers listed above, calculating the EV if the base game includes a progressive contribution (ProgressiveGrowth %) of 1.2% is calculated as EV=((90.20%*30)+(90.55%*5))/(35)+1.2%=91.55%. These calculations can be used to calculate the overall EV (the RTP) in cases where more than one add-on bonus is used, as can be seen in FIG. 4 where three add-on bonuses (bonus games A, B, and C) are installed with a primary game. Such RTP calculations are done whenever a new add-on bonus is installed and used for reporting until the configuration changes due to adding another add-on bonus or removing one or more of the bonuses.

Referring again to FIG. 1, the process next at block 318 includes operating the gaming machine with the modified configuration to provide base and bonus payouts to player. At block 320 the process includes, still automatically under control of the electronic processor, reporting game play data as the gaming machine operates to a system accounting service as a single game reflecting combined totals of the add-on bonus feature, the base game, and any previously configured additional add-on bonus features.

As can be understood, the validation, installation, and configuration steps may be repeated for more digital add-on bonus packages that install additional add-on bonus features, as long as they are compatible with the base game and any previous add-on bonuses. As discussed, the upgrade packages may provided by a configuration server on a network including multiple gaming machines, or may be provided on by a technician carrying portable digital media like USB data drive.

While add-on packages for bonus features and bonus games have been described, this is not limiting and such digital add-on packages may be employed to add suitable features that can work in combination with an existing base game. The add-on package digital media data includes celebration graphics for performance on a group display common to the target gaming machine and multiple other gaming machines in response to a designated bonus win in the add-on bonus feature, and the method further comprises, while operating the gaming machine, in response to the designate bonus win occurring, causing the group display to display the celebration graphics.

An add-on bonus may be removed from an EGM if desired, leaving the configuration with the base game and any other add-on bonuses still installed and operating. This process merely removes and alters the data in reverse order of that shown in FIG. 1. As such, some embodiments herein may include receiving a command from an operator to remove an existing add-on bonus feature of the target gaming machine and, in response, automatically under control of an electronic processor in the gaming machine removing said existing add-on bonus package by: deleting the add-on bonus package data from the target gaming machine; in the base game configuration, removing the bonus wager data and bonus payout data of the existing add-on bonus feature from the paytable and updating all references to the maximum bet, individual bets, and all prizes that scale by bet to reflect a combined bet total of the configuration without the add-on bonus. Then the process automatically calculates a new weighted average payout for the target gaming machine without the existing add-on bonus feature, including the base game and any previously configured additional add-on bonus features. Then it automatically modifies paytable data and return to player (RTP) data on the target gaming machine for reporting to a system accounting service by removing prizes for the add-on bonus feature in the paytable data and replacing the RTP data with the calculated new weighted average payout.

As can be understood, this invention provides ability to change the configuration of an EGM through add-on bonuses with the ability to dynamically change a game's bet structure outside of the variation allowed within the game's original paytable. Changing the bet structure allows add-on bonuses to increase a game's bet amounts and to use the new bet increases to fund their prizes. Typically, an add-on bonus is limited to only contributing a small percentage of the total payout, but using the designs herein allows bonuses to payout prizes from the bonus' own funds. The base game and each add-on bonus work seamlessly together but are actually separate components with separate game math and wagers. The final RTP (return to player) is then determined by doing a weighted average of all of the payouts of each component. The addition of an add-on bonus module to a base game configuration includes adding a separate wager portion for the add-on bonus module, allowing the add-on bonus to contribute to the RTP with a higher percentage than was previously possible without re-designing the base game math. For example, if an existing base game has an RTP of 98%, a bonus module may be configured with an additional wager that contributes 10% to the combined RTP, without changing the base game math.

This process of changing a games bet structure can be done during initial game configuration, or dynamically as bonuses are assigned/un-assigned from a game through the process described above. Such flexibility in configuration provides operators with the ability to dynamically configure a game to suit their needs. Internally, the game software differentiates between the different bet sources so that any given bonus can be easily added and removed. Externally, from both the player's perspective and the operator's perspective these bets are combined into what is viewed as a single game. From the player's perspective, they are presented with a set of bets to choose from, but preferably have no visibility into how the bets are divided between the various bonuses. From the operator's perspective, they preferably see the machine playing (as it reports to the system accounting server) as a single game with both coin-in and coin-out representing the combined bet and payout of all configured bonuses.

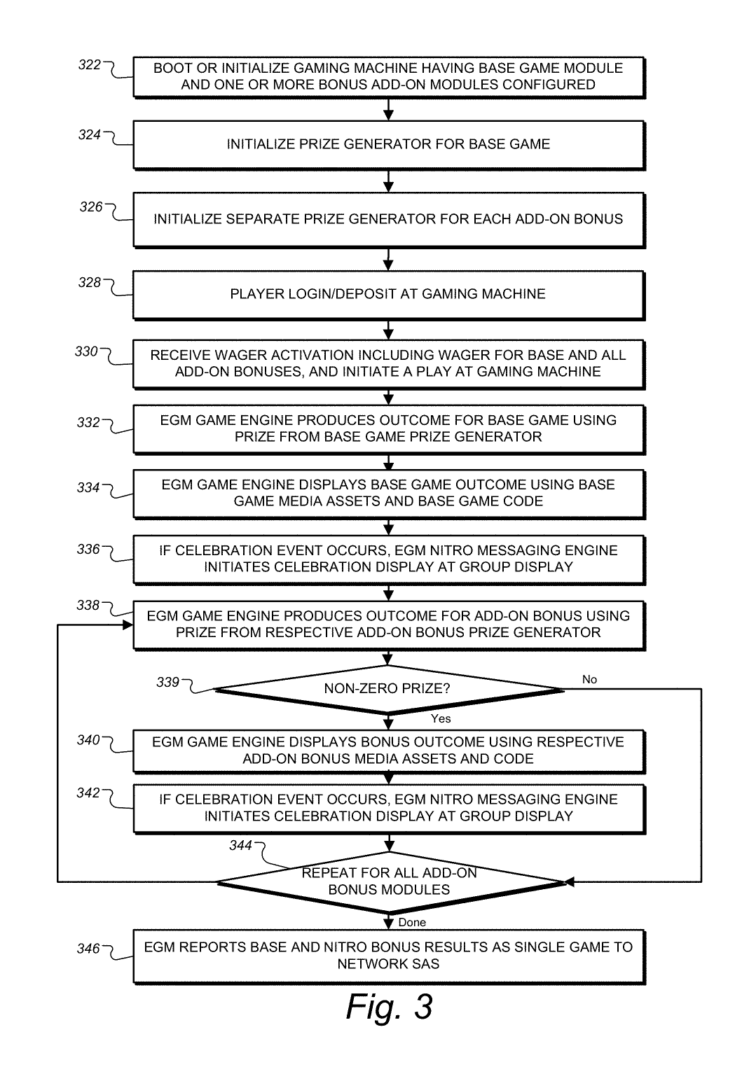

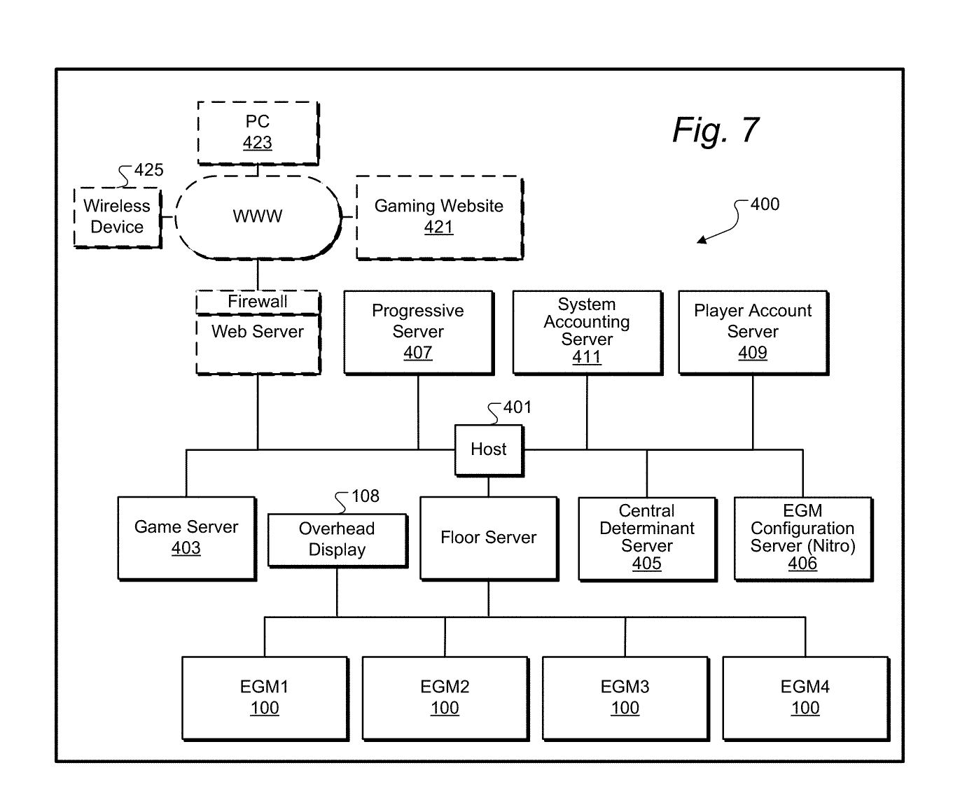

FIG. 3 is a flowchart of an example process for executing a base game in combination with a add-on bonus as configured in the example of FIG. 1 and FIG. 2. After an EGM is configured with one or more add-on bonus modules as described above, in operation the depicted process begins at block 322 where the EGM is rebooted or reinitialized into an in-revenue gaming mode, in which players may wager at the machine. The process is generally conducted by the EGM controller executing game management program code which may include scheduled tasks executed by the EGM operating system, and may include initializing other software modules or commands. The initialization includes executing the EGM's game engine software with the new configuration. This puts the EGM into attract mode, in which the screen depicts game play graphics and promotional graphics. Several software processes and services including security processes and accounting services are involved, but only those relevant to gaming operation with the add-on bonus modules will be discussed here in order to avoid obscuring the invention. At block 324, the process initializes an instantiation of the EGM prize generator (FIG. 2), the secure process that provides random or randomly selected outcomes for a game. This typically employs an random number generator (RNG) for class III games but may instead involve a secure connection to a central determinant server (405, FIG. 7) for class II games or a connection to another game server providing random or randomized (randomly selected) outcomes. Another instantiation (another running copy of the software code) is started at block 326 for each respective add-on bonus module configured to run on the EGM.

When a player decides to wager at the machine, the process goes to block 328 where a player logs in or deposits money or a credit voucher at a gaming machine through the voucher/currency acceptor 112. To begin a game play, the method receives a wager activation on a player input device at the gaming machine at block 340, which typically consists of some input from the player to set the amount to be wagered from their credit amount on the machine. These inputs may be done through the touchscreen or buttons on the player control ledge. The wager amount may also be carried over from previous game rounds by simply starting the game with the previous wager amount set. The wager, as discussed above, is divided into sub-wagers for each of the base game and the respective active add-on bonus games. The wager activation typically happens through a ‘Play’ button on the game cabinet control ledge or touchscreen display, and serves to place the wager and start a single round of game play which includes the blocks 332-344.

In response to a wager activation, the process at block 332 produces an outcome first for the base game at block 332 using the base game prize generator. In preferred versions this outcome is a credit value, which may be a credit prize or zero, randomly selected according to the game math configuration. Next, at block 334, the game code selects a presentation to provide the credit value of the award according to the base game code and the game engine proceeds to display the selected outcome using the base game media assets. In embodiments having reels, reel displays, or simulated reels, this is conducted by spinning the reels and stopping them at a stop to display symbols in a symbol array in a spin outcome for the wager. Other embodiments may otherwise rearrange or randomize the symbols on the matrix in any suitable manner. For games that use other methods of scrambling the matrix besides simulated reels, the random outcome is determined at this step as appropriate for the game. In any event, a base game round is conducted a base game round concluding with a base game result in which a matrix of symbol locations displayed on one of the gaming displays is populated with randomly selected symbols, the base game result including a possibility of winning money value credits. Preferably, any prize awarded in the base game outcome is displayed being awarded as the outcome is displayed. Next at block 336, if the base game outcome included any significant events such as large value wins or a progressive win, a celebration event may occur at block 336, in which the EGM sends a message to the group display (typically an overhead display associated with a group of gaming machines, to display a bonus celebration.

Rather than the typical bonus game process in which bonus games have a chance of occurring based on the base game outcome, with the add-on bonus modules herein, each add-on bonus herein has a probability of triggering on any given play. This determination is made separately from any events that happen on the primary game as described below. When a play is initiated, the primary game will play through an entire play cycle before the first add-on bonus game has a chance to trigger. This means that the primary game will complete its reel spin and any base game features that may trigger on that play before transitioning to the add-on bonus. Once the primary game cycle has completed, a determination is made as to whether or not the add-on bonus should trigger. Once triggered, the add-on bonus will play through in its entirety and return the EGM back to the primary game upon completion.

To accomplish the effect of presenting a bonus feature as described herein with an independent game module from the base game, a bonus game outcome is always produced for each add-on bonus after the base game, although if a zero prize outcome is produced it may not be displayed in some embodiments. This happens at block 338, where the EGM produces an outcome for the bonus game using a prize outcome generated by the respective add-on bonus prize generator. For outcomes that do produce a positive prize amount, the process goes to the add-on bonus display sequence at block 339 and an add-on bonus outcome is displayed.

The add-on bonus prizes of course follow their own, different, game math rules configured for the add-on bonus, which may have fewer winning outcomes but with larger prizes. The game engine then displays the conduct of the bonus game to provide the generated outcome generated at block 340. This is done using the EGM game engine to select and display the add-on bonus media assets necessary to display the outcome. The prize is credited to the player credit account toward the end of the display. In this embodiment, the bonus displays trigger as a mystery trigger, meaning it occurs randomly from the player point of view without an indication in the base game result of why the bonus is triggered.

Other embodiments may follow the depicted steps but generate all add-on bonus game outcomes in advance of the base game display, and then select or create a base game display sequence to include a designated bonus trigger for add-on bonus outcomes that are triggered. The same technique may be employed for second or further add-on bonuses with a trigger being displayed in the base game outcome or in the first add-on bonus (the first time through the depicted loop).

Each add-on bonus game has a chance to result in a high value award that has an associated celebration event that, if it occurs, is displayed at block 342 by the EGM system sending a message to the group display to display the appropriate event that was loaded from the add-on bonus package at its configuration. The add-on bonus blocks are repeated if there is more than one add-on bonus configured with the base game as shown at block 344.

The EGM same EGM game engine is configured to perform the game execution for both the base game module and the add-on bonus game module, including executing code from the modules, displaying graphics and audio from the modules to produce the outcome displays, and crediting prizes from both modules to the player credit account. As discussed above, the game outcomes are reported to the system accounting server at block 346 as a single, total, outcome for tracking purposes, allowing the overall conduct of the mathematically separate games of the base and add-on bonuses to be accounted for in a manner similar to prior art games in which bonus outcomes are part of the game math of a complete base game. The result is that, once an add-on bonus (referred to in the Everi Games system as a Nitro™ Bonus) package has been configured and installed, it essentially becomes fully incorporated with the primary game and augments the behavior of the game as if it was a core feature of the game itself.

The installation process of FIG. 1 may be conducted by program code operating at a gaming machine or at a configuration server (such as Nitro™ Server) as discussed above, while the game execution process of FIG. 3 is performed at the EGM 100 executing program code. Further, the program code, executable by a gaming machine or gaming network processor, as described herein are preferably executed by a Class III gaming machine which conducts all random number generation on the gaming machine or a Class II machine in which a determinant server may execute a class II game such as bingo or keno to provide outcomes for the prize generators used in the process of FIG. 3. It should be understood that this is only one example embodiment, and other versions may divide the processing tasks of the game method in a different manner. For example, some systems may employ a thin client architecture in which practically all of the processing tasks are performed at the game server, and only display information for the player interface transmitted to the electronic gaming machine. In such an embodiment, only the steps involving player input or display are performed by the electronic gaming machine, with the remaining steps performed by one of the game servers in the system. In such a case, though, the software architecture is preferably designed as a thin client in which a dedicated virtual machine running on the game server (or a virtual machine server connected in the gaming network) performs the tasks designated in the present drawing as occurring “at the gaming machine.” The base game modules and add-on bonus modules in such case would be installed on a virtual machine connected to provide processing for a designated thin client EGM on the network 400.

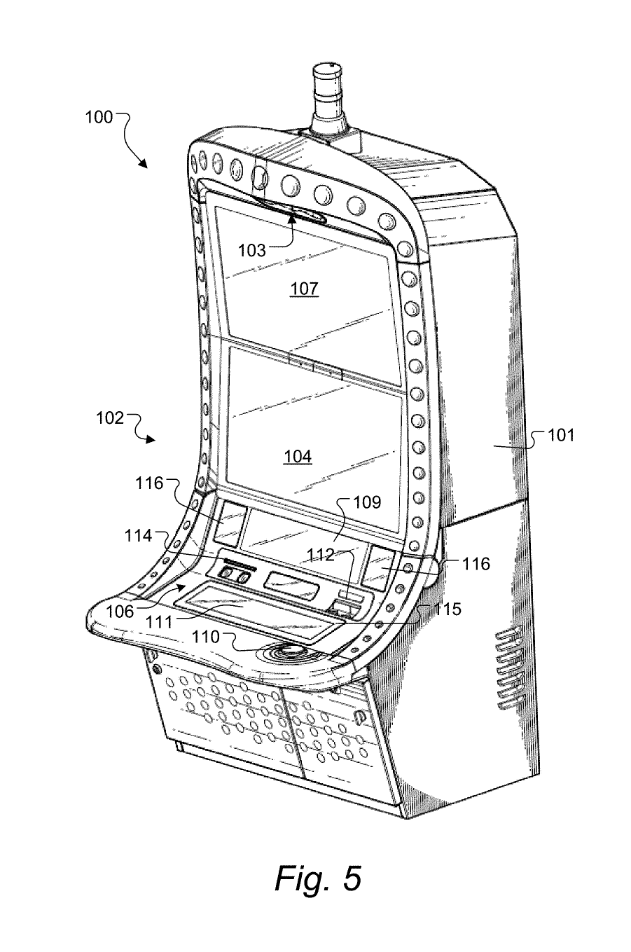

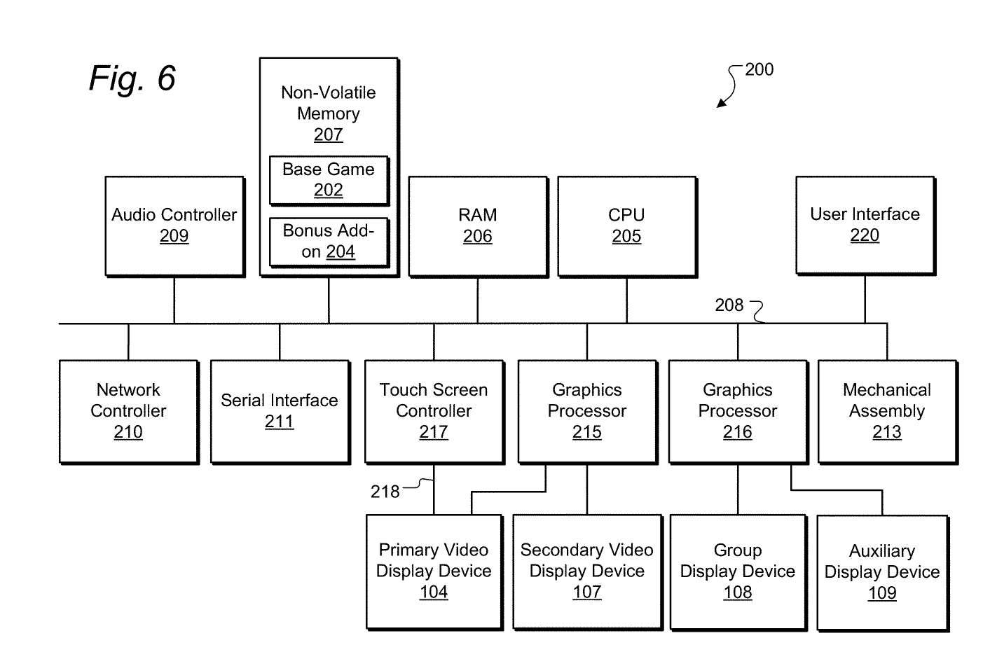

FIG. 5 shows a gaming machine 100 that may be used to implement feature games according to the present invention. The block diagram of FIG. 6 shows further details of gaming machine 100. Referring to FIG. 5, gaming machine 100 includes a cabinet 101 having a front side generally shown at reference numeral 102. A primary video display device 104 is mounted in a central portion of the front surface 102, with a ledge 106 positioned below the primary video display device and projecting forwardly from the plane of the primary video display device. In addition to primary video display device 104, the illustrated gaming machine 100 includes a secondary video display device 107 positioned above the primary video display device. Gaming machine 100 may also be connected to a group display device mounted above a group of machines (typically at least 4 machines which may be side by side or arranged in a circle). An auxiliary display device 109 may present touchscreen player controls for entering wager levels and other commands. It should also be noted that each display device referenced herein may include any suitable display device including a cathode ray tube, liquid crystal display, plasma display, LED display, or any other type of display device currently known or that may be developed in the future.

In preferred versions, the gaming machine 100 illustrated in FIG. 5 also includes a number of mechanical control buttons 110 mounted on ledge 106. These control buttons 110 may allow a player to select a bet level, select paylines, select a type of game or game feature, and actually start a play in a primary game. Further, primary video display device 104 in gaming machine 100 provides a convenient display device for implementing touchscreen controls.

It will be appreciated that gaming machines may also include a number of other player interface devices in addition to devices that are considered player controls for use in playing a particular game. The ledge may also include a hardware special object including a button, touch sensor, or switches, joysticks, or other mechanical input devices, and/or virtual buttons and other controls implemented on a suitable touchscreen video display. Gaming machine 100 also includes a currency/voucher acceptor having an input ramp 112, a player card reader having a player card input 114, and a voucher/receipt printer having a voucher/receipt output 115. Audio speakers 116 generate an audio output to enhance the user's playing experience. Numerous other types of devices may be included in gaming machines that may be used according to the present invention.

FIG. 6 shows a logical and hardware block diagram 200 of gaming machine 100 which includes a central processing unit (CPU) 205 along with random access memory 206 and nonvolatile memory or storage device 207. All of these devices are connected on a system bus 208 with an audio controller 209, a network controller 210, and a serial interface 211. A graphics processor 215 is also connected on bus 208 and is connected to drive primary video display device 104 and secondary video display device 107 (both mounted on cabinet 101 as shown in FIG. 5). A second graphics processor 216 is also connected on bus 208 in this example to drive the auxiliary display device 109 also shown in FIG. 5. Gaming machine 100 also includes a touch screen controller 217 connected to system bus 208. Touch screen controller 217 is also connected via signal path 218 to receive signals from a touchscreen element associated with primary video display device 104. It will be appreciated that the touchscreen element itself typically comprises a thin film that is secured over the display surface of primary video display device 104. The touchscreen element itself is not illustrated or referenced separately in the figures.

Those familiar with data processing devices and systems will appreciate that other basic electronic components will be included in gaming machine 100 such as a power supply, cooling systems for the various system components, audio amplifiers, and other devices that are common in gaming machines. These additional devices are omitted from the drawings so as not to obscure the present invention in unnecessary detail.

All of the elements 205, 206, 207, 208, 209, 210, and 211 shown in FIG. 6 are elements commonly associated with a personal computer system architecture. These elements are preferably mounted on a standard personal computer chassis and housed in a standard personal computer housing which is itself mounted in cabinet 101 shown in FIG. 5. Alternatively, the various electronic components may be mounted on one or more circuit boards housed within cabinet 101 without a separate enclosure such as those found in personal computers. Those familiar with data processing systems and the various data processing elements shown in FIG. 6 will appreciate that many variations on this illustrated structure may be used within the scope of the present invention. For example, since serial communications are commonly employed to communicate with a touch screen controller such as touch screen controller 217, the touch screen controller may not be connected on system bus 208, but instead include a serial communications line to serial interface 211, which may be a USB controller or a IEEE 1394 controller for example. It will also be appreciated that some of the devices shown in FIG. 6 as being connected directly on system bus 208 may in fact communicate with the other system components through a suitable expansion bus. Audio controller 209, for example, may be connected to the system via a PCI bus. System bus 208 is shown in FIG. 6 merely to indicate that the various components are connected in some fashion for communication with CPU 205 and is not intended to limit the invention to any particular bus architecture. Numerous other variations in the gaming machine internal structure and system may be used without departing from the principles of the present invention.

It will also be appreciated that graphics processors are also commonly a part of modern computer systems. Although separate graphics processor 215 is shown for controlling primary video display device 104 and secondary video display device 107, and graphics processor 216 is shown for controlling both auxiliary display devices 108 and 109, it will be appreciated that CPU 205 may control all of the display devices directly without any intermediate graphics processor. The group display device 108 may include its own controller and graphics processor for driving the group display in response to commands received over a network connection from the connected group of gaming machines. The invention is not limited to any particular arrangement of processing devices for controlling the video display device included with gaming machine 100. Also, a gaming machine implementing the present invention is not limited to any particular number of video display devices or other types of display devices.

In the illustrated gaming machine 100, CPU 205 executes software which ultimately controls the entire gaming machine including the receipt of player inputs and the presentation of the graphic symbols displayed according to the invention through the display devices 104, 107, 108, and 109 associated with the gaming machine. As will be discussed further below, CPU 205 either alone or in combination with graphics processor 215 may implement a presentation controller for performing functions associated with a primary game that may be available through the gaming machine, and may also implement a game client for directing one or more display devices at the gaming machine to display the feature game mode according to the present invention. CPU 205 also executes software related to communications handled through network controller 210, and software related to various peripheral devices such as those connected to the system through audio controller 209, serial interface 211, and touch screen controller 217. CPU 205 may also execute software to perform accounting functions associated with game play. Random access memory 206 provides memory for use by CPU 205 in executing its various software programs, while the nonvolatile memory or storage device 207 may comprise a hard drive or other mass storage device providing storage for programs not in use or for other data generated or used in the course of gaming machine operation. Network controller 210 provides an interface to other components of a gaming system in which gaming machine 100 is included. In particular, network controller 210 provides an interface to a game controller which controls certain aspects of the persistent game mode as will be discussed below in connection with FIG. 6.

It should be noted that the invention is not limited to gaming machines employing the arrangement of processing devices and interfaces shown in example gaming machine 100. Other gaming machines through which the features herein are implemented may include one or more special purpose processing devices to perform the various processing steps for implementing the present invention, such as generating random numbers or checking the security status of software packages or gaming credit vouchers. Unlike processing devices such as CPU 205, these special purpose processing devices may not employ operational program code to direct the various processing steps.

Still referring to the hardware and logical block diagram 200 showing an example design for a gaming machine 100, the depicted machine in operation is controlled generally by CPU 205 which stores operating programs and data in memory 207 with base game 202, add-on bonus 204, user interface 220, network controller 210, audio/visual controllers, and reel assembly 213 (if mechanical reel configuration). The add-on bonus 204, once installed, also is held in non-volatile memory of the EGM, preferably a separate flash drive or hard drive from the memory holding the EGM operating system. CPU or game processor 205 may comprise a conventional microprocessor, such as an Intel microprocessor, mounted on a printed circuit board with supporting ports, drivers, memory, software, and firmware to communicate with and control gaming machine operations, such as through the execution of coding stored in memory 207 including one or more base games 202, and bonus modules 204. Game processor 205 connects to user interface 220 such that a player may enter input information, and game processor 205 may respond according to its programming, such as to apply a wager and initiate execution of a game.

Game processor 205 also may connect through network controller 210 to a gaming network, such as example casino server network 400 shown in FIG. 7. Referring now to FIG. 7, the casino server network 400 may be implemented over one or more site locations and include host server 401, and an EGM configuration server 406 (in the preferred version the Everi Games Nitro™ Host server) for managing the configuration of multiple EGMs 100 on the network. The network may also include remote game play server 403 (which may be configured to provide game processor functionality including determining game outcomes and providing audio/visual instructions to a remote gaming device), central determinant server 405 (which may be configured to determine lottery, bingo, or other centrally determined game outcomes and provide the information to networked gaming machines 100 providing lottery and bingo-based wagering games to patrons), progressive server 407 (which may be configured to accumulate a progressive pool from a portion of wagering proceeds or operator marketing funds and to award progressive awards upon the occurrence of a progressive award winning event to one or more networked gaming machines 100), player account server 409 (which may be configured to collect and store player information and/or awards and to provide player information to gaming machines 100 after receiving player identification information such as from a player card), and accounting server 411 (which may be configured to receive and store data from networked gaming machines 100 and to use the data to provide reports and analyses to an operator). Through its network connection, gaming machine 100 may be monitored by an operator through one or more servers such as to assure proper operation, and, data and information may be shared between gaming machine 100 and respective of the servers in the network such as to accumulate or provide player promotional value, to provide server-based games, or to pay server-based awards.

Referring to FIG. 7, a block diagram of an example networked gaming system 400 associated with one or more gaming facilities is shown, including one or more networked gaming machines 100 in accordance with one or more embodiments. While some of the servers have been shown separately, they may be combined or split into additional servers having additional capabilities.

As shown, networked gaming machines 100 (EGM1-EGM4) and one or more overhead group displays 408 may be network connected and enable the content of one or more displays of gaming machines 100 to be mirrored or replayed on an overhead display. EGMs 100 may also feed celebration graphics directly to the overhead displays 408 in the course of providing games, for example to show a celebration for a large bonus win on a particular EGM 100. The primary display content may also be stored by the display controller or game processor 205 and transmitted through network controller 210 to the overhead display controller either substantially simultaneously or at a subsequent time according to either periodic programming executed by game processor 205 or a triggering event, such as a jackpot or large win, at a respective gaming machine 100. In the event that gaming machines 100 have cameras installed, the respective player's video images may be displayed on overhead display 408 along with the content of the player's gaming machine 100 and any associated audio feed.

In one or more embodiments, game server 403 may provide server-based games and/or game services to network connected gaming devices, such as gaming machines 100 (which may be connected by network cable or wirelessly). Progressive server 407 may accumulate progressive awards by receiving defined amounts (such as a percentage of the wagers from eligible gaming devices or by receiving funding from marketing or casino funds) and provide progressive awards to winning gaming devices upon a progressive event, such as a progressive jackpot game outcome or other triggering event such as a random or pseudo-random win determination at a networked gaming device or server (such as to provide a large potential award to players playing the community feature game). Progressive prizes may be made available to be won through display on the when enhancement feature game wheel's symbol locations 502, and may be added to the wheel by either a symbol location modifier or a wheel modifier type player selectable event 503 in the course of the wheel enhancement feature game. Accounting server 411 may receive gaming data from each of the networked gaming devices, perform audit functions, and provide data for analysis programs, such as the IGT Mariposa program bundle.

Player account server 409 may maintain player account records, and store persistent player data such as accumulated player points and/or player preferences (e.g. game personalizing selections or options). For example, the player tracking display may be programmed to display a player menu that may include a choice of personalized gaming selections that may be applied to a gaming machine 100 being played by the player.

In one or more embodiments, the player menu may be programmed to display after a player inserts a player card into the card reader. When the card reader is inserted, an identification may be read from the card and transmitted to player account server 409. Player account server 409 transmits player information through network controller 210 to user interface 220 for display on the player tracking display. The player tracking display may provide a personalized welcome to the player, the player's current player points, and any additional personalized data. If the player has not previously made a selection, then this information may or may not be displayed. Once the player makes a personalizing selection, the information may be transmitted to game processor 205 for storing and use during the player's game play. Also, the player's selection may be transmitted to player account server 409 where it may be stored in association with the player's account for transmission to the player in future gaming sessions. The player may change selections at any time using the player tracking display (which may be touch sensitive or have player-selectable buttons associated with the various display selections).

In one or more embodiments, a gaming website may be accessible by players, e.g. gaming website 421, whereon one or more games may be displayed as described herein and played by a player such as through the use of personal computer 423 or handheld wireless device 425 (e.g. Apple iPhone, Android phone, tablet, phablet, virtual reality device, iPad, etc.). To enter the website, a player may log in with a username (that may be associated with the player's account information stored on player account server 409 or be accessible by a casino operator to obtain player data and provide promotional offers), play various games on the website, make various personalizing selections and save the information, so that during a next gaming session at a casino establishment, the player's playing data and personalized information may be associated with the player's account and accessible at the player's selected gaming machine 100.

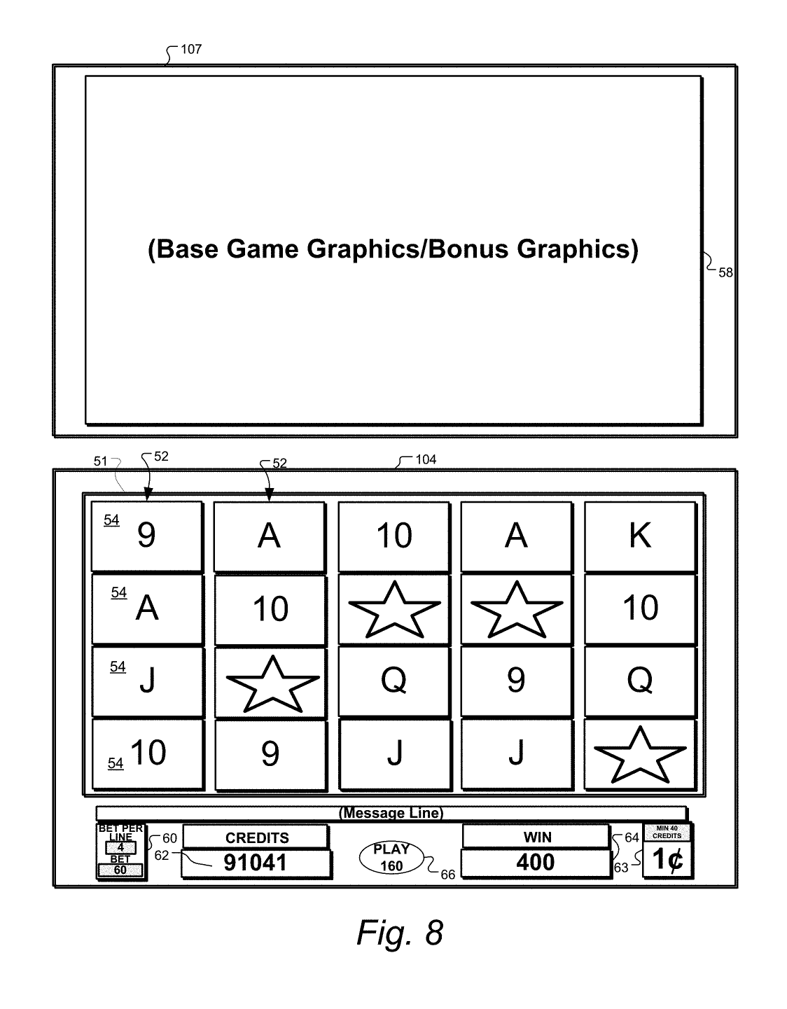

FIG. 8 is a game screen diagram illustrating a base game mode showing the primary display 104 and secondary (top) display 107 to illustrate an example slot machine display arrangement on which wagering game results are presented in a gaming area, typically found on the primary display. Background, side, and top graphics may be animated during or between games as part of the multimedia theme of the game as further discussed below.

The gaming area of a reel-type primary game in this version is a matrix 51 of symbol locations arranged in rows and columns to represent simulated slot machine reels that are spun to conduct a game round. Add-on bonus games as described herein may also be reel-type games or other types of games. Other embodiments may, of course, use other types of game displays to display randomizing of symbols according to the methods herein. The depicted columns of symbols labeled 52 represent the simulated reels, while symbols are shown in each symbol location designated 54. In this instance there are five reels with four symbol locations 54 displayed at a time on each reel, but the game can be played with more and less reels. The simulated reel typically has far more symbols than those displayed, and as many unique stop positions as there are symbols on the simulated reel. The stop position may be counted, for example, by numbering the symbols on the simulated reel and using the number of the symbol at the bottom of the display window (the three symbols displayed in this example), or at the top or middle. Further, while multi-symbol reels are shown, other versions may use simulated uni-symbol reels, or a reel that has many symbols thereon but only a single window to the reel simulated, displaying a single symbol from the reel. Some variations of the present invention may use a simulated uni-symbol reel in each depicted symbol location 54. Surrounding the matrix 51 is background graphics 53, which may be above, beside, below, between or behind the symbol locations 54 of matrix 51.

Winning patterns are typically formed by matching symbols along defined paylines that pass through the matrix 51. Box 60, which displays the current wager and amount bet per payline. Other versions may not have a designated bet per line. To the right of box 60 is box 62, which displays the current credits in the player's account. In the bottom center a touchscreen play button 66 is presented in the lower central area of the display, which may show other game state related graphics. Right of this is win box 64, which displays the player's last awarded winnings. The wager credit denomination is shown in box 63. Along the bottom edge of the matrix 51 there is a message line, where the game station can display further instructions to the player.

Referring generally to the description herein, any use of ordinal terms such as “first,” “second,” “third,” etc., to refer to an element does not by itself connote any priority, precedence, or order of one element over another, or the temporal order in which acts of a method are performed. Rather, unless specifically stated otherwise, such ordinal terms are used merely as labels to distinguish one element having a certain name from another element having a same name (but for use of the ordinal term).

Further, as described herein, the various features have been provided in the context of various described embodiments, but may be used in other embodiments. The combinations of features described herein should not be interpreted to be limiting, and the features herein may be used in any working combination or sub-combination according to the invention. This description should therefore be interpreted as providing written support, under U.S. patent law and any relevant foreign patent laws, for any working combination or some sub-combination of the features herein.

The above described preferred embodiments are intended to illustrate the principles of the invention, but not to limit the scope of the invention. Various other embodiments and modifications to these preferred embodiments may be made by those skilled in the art without departing from the scope of the present invention.

1. A method of reconfiguring a gaming machine to provide and remove add-on bonus features to and from an existing base game on the gaming machine, the method comprising:
(a) providing a digital add-on bonus package, said package including (i) first data describing game math for an add-on bonus feature separately from any base game to which the add-on may be applied, including bonus wager data and bonus payout data; (ii) second digital media data including graphics and sounds for all media features and sequences to be employed for executing the add-on bonus feature and any related media presentations; (iii) a manifest containing validation data for said add-on bonus package;
(b) receiving a command from an operator to modify an existing base game of a target gaming machine based on said add-on bonus package and, in response, automatically under control of an electronic processor in the gaming machine installing said add-on bonus package by: (i) and unpacking and validating said add-on bonus package, and copying its contents to the target gaming machine, (ii) in the base game configuration, increasing all wager levels in a base game paytable by the bonus wager, adding the bonus payout data to the paytable and updating all references to the maximum bet, individual bets, and all prizes that scale by bet to reflect a combined bet total of the previous configuration and the add-on bonus;
(c) automatically under control of the electronic processor, calculating a weighted average payout for the target gaming machine including the add-on bonus feature, the base game, and any previously configured additional add-on bonus features;
(d) automatically under control of the electronic processor, modifying paytable data and return to player (RTP) data on the target gaming machine for reporting to a system accounting service by adding prizes for the add-on bonus feature in the paytable data and replacing the RTP data with the calculated weighted average payout;
(e) operating the gaming machine with the modified configuration to provide base and bonus payouts to players;
(f) while operating the gaming machine, automatically under control of the electronic processor, reporting game play data to a system accounting service as a single game reflecting combined totals of the add-on bonus feature, the base game, and any previously configured additional add-on bonus features.

2. The method of claim 1, in which the upgrade package is provided at an upgrade server on a network including multiple gaming machines.

3. The method of claim 1, further repeating steps (a)-(f) for an additional digital add-on bonus package adding an additional add-on bonus feature.

4. The method of claim 1, in which the second digital media data includes celebration graphics for performance on a group display common to the target gaming machine and multiple other gaming machines in response to a designated bonus win in the add-on bonus feature, and the method further comprises, while operating the gaming machine, in response to the designate bonus win occurring, causing the group display to display the celebration graphics.

5. The method of claim 1, further comprising:
(a) receiving a command from an operator to remove an existing add-on bonus feature of the target gaming machine and, in response, automatically under control of an electronic processor in the gaming machine removing said existing add-on bonus package by: (i) deleting the add-on bonus package data from the target gaming machine; (ii) in the base game configuration, removing the bonus wager data and bonus payout data of the existing add-on bonus feature from the paytable and updating all references to the maximum bet, individual bets, and all prizes that scale by bet to reflect a combined bet total of the configuration without the add-on bonus;
(b) automatically under control of the electronic processor, calculating a new weighted average payout for the target gaming machine without the existing add-on bonus feature, including the base game and any previously configured additional add-on bonus features; and
(c) automatically under control of the electronic processor, modifying paytable data and return to player (RTP) data on the target gaming machine for reporting to a system accounting service by removing prizes for the add-on bonus feature in the paytable data and replacing the RTP data with the calculated new weighted average payout.

6. A method of providing multiple game results at an electronic gaming machine, the method conducted under control of one or more electronic processors executing program code at the gaming machine, the method comprising:
providing a base game module approved by regulators to operate as a casino slot machine game;
providing an add-on bonus game module approved by regulators to operate as a casino slot machine game independently of the base game module;
instantiating a first prize generator for the base game module;
instantiating a second prize generator for the add-on bonus game module independent of the first prize generator;
instantiating a game engine configured to perform game execution for both the base game module and add-on bonus module;
receiving a wager input from a player with an associated wager amount and crediting a first portion of the wager amount to a base game wager and a second portion of the wager amount to an add-on bonus game wager;
producing a base game prize amount with the first prize generator and displaying a base game round being conducted to produce the base game prize amount using program code and graphics from the base game module;
producing an add-on bonus game prize amount with the second prize generator and, immediately following displaying the base game round being conducted, displaying an add-on bonus game round being conducted to produce the add-on bonus game prize amount using program code and graphics from the add-on bonus game module;
causing an award including money value credits won to be transferred to a player credit account redeemable for money value; and
calculating combined totals of the base game and add-on bonus game wagers and the base game and add-on bonus game awards, and reporting the combined totals to a system accounting service as a single game wager and result.

7. The method of claim 6, further comprising, in response to a designated large add-on bonus game prize being achieved, causing a group display to display celebration graphics from the add-on bonus module.

8. The method of claim 7, in which causing the group display to display the celebration graphics comprises sending a message to a group display server to display a graphic sequence based on celebration graphics data installed on the group display server from the add-on bonus module.

9. The method of claim 7, in which causing the group display to display the celebration graphics comprises streaming a video signal from the gaming machine to the group display.

10. The method of claim 7, further comprising, immediately following displaying the add on bonus game round, producing and displaying a game result from an additional add-on bonus module having regulatory approval to operate as a casino slot machine game independently of the base game module and the add-on bonus module.

11. A gaming machine comprising:
a cabinet holding one or more video displays;
an electronic controller operatively coupled to control the one or more video displays and one or more tangible, non-transitory computer media operatively coupled to the controller;
a credit input device in communication with the controller and adapted for accepting a physical item associated with a monetary value that establishes a player credit balance;
a plurality of player-activated input devices in communication with the controller for setting wagers covered by the credit balance and initiating games for determining the outcomes of the wagers;
a base game module stored in at least one of the computer readable media, the base game module approved by regulators to operate as a casino slot machine game;
an add-on bonus game module stored in at least one of the computer readable media, the add-on bonus game module approved by regulators to operate as a casino slot machine game independently of the base game module;
game management program code stored in at least one of the computer readable media and executable by the controller for instantiating a first prize generator for the base game module and instantiating a second prize generator for the add-on bonus game module independent of the first prize generator;
game engine program code stored in at least one of the computer readable media and executable by the controller to perform game execution for both the base game module and add-on bonus module including:
(a) receiving a wager input from a player with an associated wager amount and crediting a first portion of the wager amount to a base game wager and a second portion of the wager amount to an add-on bonus game wager;
(b) producing a base game prize amount with the first prize generator and displaying a base game round being conducted to produce the base game prize amount using program code and graphics from the base game module;
(c) producing an add-on bonus game prize amount with the second prize generator and, immediately following displaying the base game round being conducted, displaying an add-on bonus game round being conducted to produce the add-on bonus game prize amount using program code and graphics from the add-on bonus game module;
(d) causing an award including money value credits won to be transferred to a player credit account redeemable for money value; and
(e) calculating combined totals of the base game and add-on bonus game wagers and the base game and add-on bonus game awards, and reporting the combined totals to a system accounting service as a single game wager and result.

12. The gaming machine of claim 11, in which the game management program code is further executable for, in response to a designated large add-on bonus game prize being achieved, causing a group display to display celebration graphics from the add-on bonus module.

13. The gaming machine of claim 12, in which causing the group display to display the celebration graphics comprises sending a message to a group display server to display a graphic sequence based on celebration graphics data installed on the group display server from the add-on bonus module.

14. The gaming machine of claim 12, in which causing the group display to display the celebration graphics comprises streaming a video signal from the gaming machine to the group display.

15. The gaming machine of claim 12, in which the game engine program code is further executable for, immediately following displaying the add on bonus game round, producing and displaying a game result from an additional add-on bonus module having regulatory approval to operate as a casino slot machine game independently of the base game module and the add-on bonus module.
